(19) United States
(12) Patent Application Publication
(10) Pub. No.: US 2013/0242243 A1
(43) Pub. Date: Sep. 19, 2013

(54) METHODS AND APPARATUS FOR CONNECTING ELECTRICALLY CONDUCTIVE GLASS TO A SUBSTRATE IN A LIQUID CRYSTAL PANEL

(71) Applicant: Frank Supon, Louisville, CO (US)

(72) Inventor: Frank Supon, Louisville, CO (US)

(21) Appl. No.: 13/423,054

(22) Filed: Mar. 16, 2012

(51) Int. Cl. G02F 1/1333

(52) U.S. Cl. 349/122

(57) ABSTRACT

A liquid crystal panel and method are disclosed for increasing reliability in the panel by using an electrically conductive gap filler arranged to transfer electrical signals between a substrate and a transparent electrically conductive glass of the liquid crystal panel.

### FIELD OF THE INVENTION

Embodiments of the present invention are generally related to the field of liquid crystal displays, and, more particularly, to the optical performance of such displays.

### BACKGROUND

A liquid crystal (LC) display cell can have an electrically conductive glass layer over a liquid crystal layer which can be supported by a silicon backplane substrate. The LC display cell can be die-attached to a printed circuit board or other substrate to produce an LC panel. The printed circuit board can be used to make electrical connections to the cell for power and data purposes. A conventional LC panel can have one or more electrical connections directly between the electrically conductive glass and the printed circuit board. These electrical connections can be made from a conductive adhesive which can be formed into one or more pillars to connect a conductive layer of the conductive glass to a conductive trace on the circuit board. Power can be supplied from the printed circuit board to the conductive glass through the conductive adhesive pillar without passing through the silicon substrate.

A diagrammatic elevational view of a conventional LC panel is shown in FIG. 1 and is generally designated using reference number 10. Panel 10 can have a display cell 12 die-attached to a printed circuit board substrate 14, such as FR4. Display cell 12 can include an electrically conductive glass layer 16, a liquid crystal layer 18 and a silicon backplane substrate 20. Other layers can be included but are not shown in this simplified example for purposes of clarity. The electrically conductive glass can have an overhang where the glass overhangs the LC and silicon substrate layers. A pillar 24 of conductive adhesive can be formed between the printed circuit board and overhang of the conductive glass to electrically connect the printed circuit board substrate to the conductive glass. In this arrangement, the pillar does not contact the LC or silicon backplane substrate layers, but instead extends directly from the printed circuit board to the conductive glass.

During operation, the display cell applies electrical field signals across the liquid crystal layer between pixel electrodes of the silicon backplane substrate and the electrically conductive glass to change a characteristic of the liquid crystal to modulate light for creating an image. If the electrical connection through the pillar is broken, then the display cell is unable to create the electrical fields and the display cell becomes non-functional.

The pillar can be formed after display cell 12 is die-attached to the printed circuit board substrate using carefully controlled dispense methods and custom made dispensing equipment. The formation of the pillar is not a typical manufacturing process and the need to form the pillar in a LC panel limits the number of available manufacturing vendors.

The pillar can be a source of failure in the LC panel. Since the pillar has to span at least the thickness of the silicon substrate and the LC layer, the pillar can be on the order of 0.7 mm high to span the distance between the conductive glass layer and the circuit board substrate. The thickness/height of the pillar can exceed the recommended maximum thickness of the conductive adhesive to form the posts. As a result of the required thickness/height, the pillar can be subject to handling related mechanical failure. The pillar can also be subject to failure caused by adverse environmental conditions, such as high temperature and high humidity.

In some circumstances the pillar can be broken because the conductive adhesive from which the pillar is made can have a coefficient of thermal expansion CTE which is different than a CTE of the silicon backplane substrate of the display cell. Because of this CTE difference, the silicon backplane substrate and the pillar can expand and contract at different rates in response to temperature fluctuations. When this happens, mechanical stresses are created on the pillar and the pillar can break. Once the pillar is broken, the LC panel ceases to function properly.

The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF THE DRAWINGS

FIG. 1 is a diagrammatic side view of certain layers of a conventional liquid crystal panel.

FIG. 2 is a diagrammatic side view of an embodiment of a liquid crystal panel having an electrical connection according to the present disclosure.

FIG. 3 is a diagrammatic top view of an embodiment of a liquid crystal panel having an electrical connection according to the present disclosure.

FIG. 4 is a diagrammatic side view of another embodiment of a liquid crystal panel having an electrical connection according to the present disclosure.

FIG. 5 is a diagrammatic side view illustrating the assembly of an embodiment of a liquid crystal panel having an electrical connection according to the present disclosure.

FIG. 6 is a flow diagram illustrating an embodiment of a method involving the assembly of a liquid crystal panel according to the present disclosure.

FIG. 7 is a diagrammatic side view illustrating the assembly of another embodiment of a liquid crystal panel having an electrical connection according to the present disclosure.

FIG. 8 is a flow diagram illustrating another embodiment of a method involving the assembly of a liquid crystal panel according to the present disclosure.

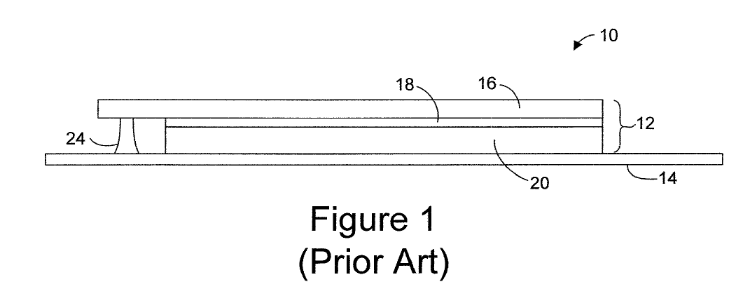

### DETAILED DESCRIPTION

The following description is presented to enable one of ordinary skill in the art to make and use embodiments of the invention and is provided in the context of a patent application and its requirements. Various modifications to the described embodiments will be readily apparent to those skilled in the art and the generic principles taught herein may be applied to other embodiments. Thus, embodiments of the present invention are not intended to be limited to the embodiments shown, but are to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

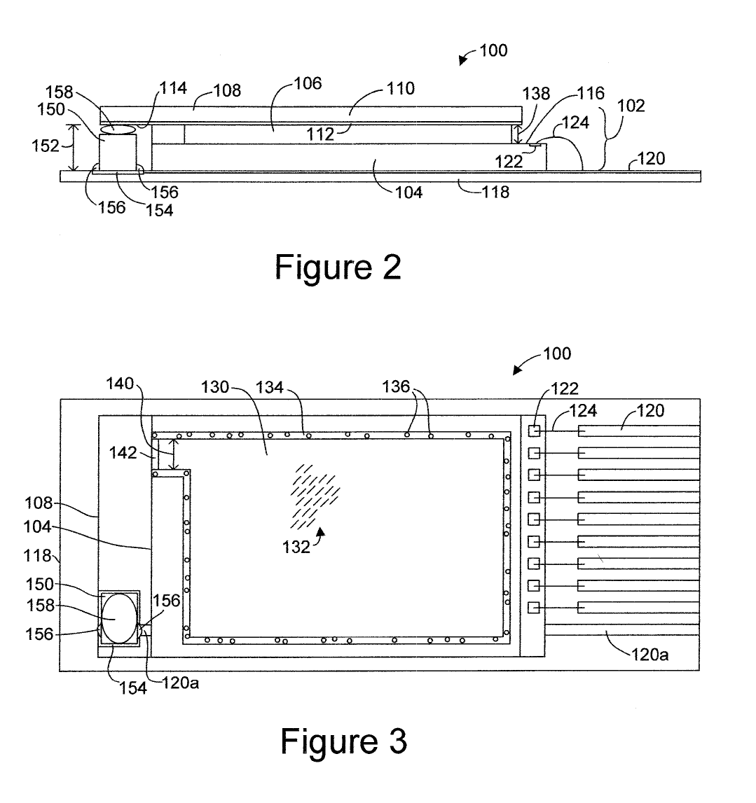

Attention is now directed to the remaining figures wherein like reference numbers may refer to like components throughout the various views. FIG. 2 is a diagrammatic representation of an embodiment of a liquid crystal on silicon (LCOS) panel in a side view, generally indicated by reference number 100. LCOS panel 100 includes a liquid crystal (LC) cell 102 having a silicon backplane die 104, an LC layer 106 and a transparent electrically conductive glass 108. The transparent electrically conductive glass can include a glass layer 110 and a transparent electrical conductor layer 112 formed from a transparent electrically conductive material such as, indium-tin-oxide (ITO). As can be seen from the diagrammatic side view of FIG. 2, transparent electrically conductive glass 108 can be offset from silicon backplane die 104 and LC layer 106 to create an overhang 114 on one end of the LC cell and a shelf 116 on the opposite end of the LC cell.

LCOS panel 100 can include a substrate 118, such as a flexible printed circuit board, an FR4 printed circuit board or other substrate which includes electrically conductive traces 120 or other conductors for carrying electrical signals to and/or from the LC cell. The LC cell can be die-attached to the substrate using conventional die-attach methods to bond the silicon backplane die to substrate 118. The silicon backplane die can have one or more bond pads 122 positioned on shelf 116 for electrically connecting to traces 120 using wire bonds 124 to transfer the electrical signals between substrate 118 and LC cell 102.

Referring now to FIG. 3 in conjunction with FIG. 2, the former is a diagrammatic top view of LCOS panel 100. LC layer 106 can include a liquid crystal material 132 and a liquid crystal perimeter seal 134. Perimeter seal 134, electrically conductive glass 108 and silicon backplane die 104 can form the boundaries of a liquid crystal reservoir 130 which contains the liquid crystal material. During the assembly of the display cell, the liquid crystal perimeter seal can be formed on either the electrically conductive glass or the silicon backplane die. The liquid crystal perimeter seal can be made from an adhesive and can be applied using a syringe needle or can be printed using offset printing, an ink jet printer, or other suitable printing or application methods. The perimeter seal can bond the electrically conductive glass to the silicon backplane die to create laminated display cell 102.

The liquid crystal layer can have spacers 136 which can be located in the perimeter seal and/or in the reservoir to maintain a gap 138 (FIG. 2) between the electrically conductive glass and the silicon backplane die. The spacers can be particles of silica or polymer or another material having a specific dimension that is substantially the same as gap 138. During manufacture, the perimeter seal can be formed with an opening 140 so that the reservoir can be filled with liquid crystal material 134 after the perimeter seal has cured. After the reservoir is filled through the opening, the reservoir can be sealed with a plug 142 which can be formed using an adhesive such as the adhesive used for the perimeter seal.

LCOS panel 100 can include an electrically conductive gap filler 150. Gap filler 150 can be positioned in an overhang gap 152 between electrically conductive glass 108 and substrate 118 when the LC cell is attached to substrate 118. The gap filler is electrically conductive and a first side of the gap filler can be electrically connected to a bond pad 154 of substrate 118 using an electrically conductive bonding material 156. Bond pad 154 can be connected to a signal source for powering electrically conductive glass 108 through a circuit trace 120a. Circuit trace 120a and bond pad 154 can be part of substrate 118 and circuit trace 120a that can extend under the LC cell. An opposite side of gap filler 150 can be electrically connected to transparent electrically conductive layer 112 of electrically conductive glass 108 using an electrically conductive bonding material 158. The gap filler can span a majority of the overhang gap or substantially the entire overhang gap depending on a thickness of the electrically conductive bonding material used. Electrically conductive bonding material 158 can be used to span any distance in the overhang gap that is not spanned by the gap filler. Electrically conductive glass 108 can be powered through circuit trace 120a, bond pad 154, gap filler 150 and conductive bonding material 158.

Gap filler 150 can be made, by way of non-limiting example, from an electrically conductive material, such as for example, gold plated bronze, gold plated copper, metal plated ceramic, such as for example a surface mount resistor, or other material such as a solid conductive metal or other conductive material. The gap filler can be formed in different shapes, such as for example, those having rectangular surface areas as show in FIGS. 2 and 3 or in a cylindrical shape as is discussed below, or any other suitable shape that can be used for conducting electricity and which has a dimension that is suitable for spanning the majority of overhang gap 152. The shape can be customized in view of the contact resistance needed as well as the particular types of attachments/electrical connections that are used in an embodiment. In an embodiment, overhang gap 152 can be on the order of approximately 0.7 mm, such that the gap filler can be approximately 0.6 mm and conductive bonding material 158 can be approximately 0.1 mm in height in view of FIG. 2.

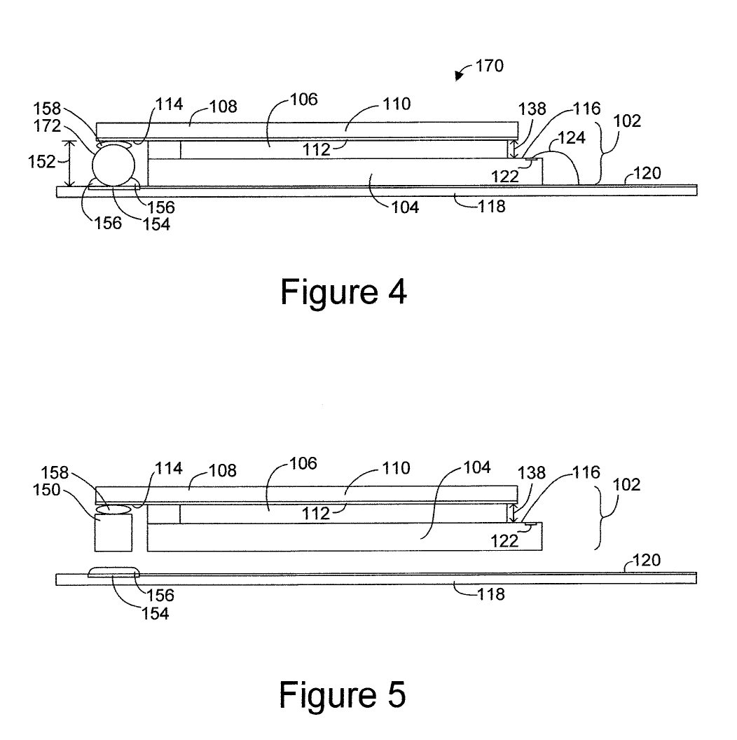

Referring now to FIG. 4, a diagrammatic side view of an LCOS panel is generally indicated by reference number 170. LCOS panel 170 includes an at least generally cylindrically shaped gap filler 172 that is positioned between bond pad 154 and transparent electrically conductive glass 108. Gap filler 172 can be electrically and physically attached to substrate 118 using electrically conductive bonding material 156 and can be electrically and physically attached to electrically conductive glass 108 using electrically conductive bonding material 158. The cylindrically shaped gap filler can be made using an elongated stock material such as a length of wire having a suitable diameter and gap filler 172 can be oriented such that electricity can travel across the diameter or cross-sectional width of the cylindrically shaped gap filler in a direction that is at least generally transverse to the elongation axis to electrically connect the bond pad of the substrate to the electrically conductive glass. The length of the cylindrically shaped gap filler can be based on available space in view of contact resistance requirements. The cross-sectional shape of the elongated gap filler can be any suitable shape including, but not limited to elliptical, trapezoidal, a parallelogram, an asymmetrical shape, and a rectangular shape. Moreover, the elongation axis is not required to be straight but can be curved to suit a particular application. Further, the elongation axis is not required to be parallel to other features of the assembled panel such as, for example, the near edges of the die or transparent glass.

Irrespective of any particular shape, the gap filler can be a material that has a coefficient of thermal expansion (CTE) that is similar to a CTE of silicon backplane die 104, such as by way of non-limiting example, a metal clad ceramic. During temperature fluctuations, overhang gap 152 between electrically conductive glass 108 and substrate 118 can increase and decrease in size due at least partially to thermal expansion and contraction of the silicon backplane die. By selecting the gap filler material having a CTE that is similar to the CTE of the silicon backplane die, the gap filler can expand and contract at a similar rate to match related behavior of the silicon backplane die. For example, when the silicon backplane die expands, the overhang gap increases in height and the gap filler expands to continue to span the increased size of the overhang gap. In this situation, if the gap filler has a CTE that is substantially different from the CTE of the silicon backplane die, the gap filler may expand more than the silicon backplane die, in which case the gap filler may de-laminate display cell 102 or break one of the layer of the LCOS panel. On the other hand, the gap filler may not expand as much as the silicon backplane die and the overhang gap, in which case the electrical connection across the overhang gap may be broken. In either case, the LCOS panel may be rendered non-functional. Damage to LCOS panel 100 can be reduced or eliminated if the CTE of the gap filler is close enough to the CTE of the silicon backplane die. Conventional pillars made entirely from conductive adhesive can fail due to thermally induced expansion and contraction because the CTE of the conductive adhesive can be dissimilar to the CTE of the silicon backplane die. For increased reliability over a conventional LCOS panel having a pillar made from a conductive adhesive, the CTE of the gap filler can be closer to the CTE of the silicon backplane die than to a CTE of the conductive adhesive used to electrically connect the gap filler to the electrically conductive glass.

In one embodiment, electrically conductive bonding material 158 can be a conductive adhesive, such as an ultra-violet curing acrylic adhesive, epoxy adhesive or other optical adhesive. In another embodiment, the gap filler is soldered to the electrically conductive layer, for example, by using an indium-tin solder when the electrical conductor layer is indium-tin-oxide. Electrically conductive bonding material 156 can also be a conductive adhesive, or the gap filler may be soldered to substrate 118 using a soldering method such as a conventional reflow soldering technique. The gap filler can be soldered to the substrate while being electrically connected to the electrically conductive glass by conductive adhesive. The gap filler can also be electrically connected to both the electrically conductive glass and the substrate using conductive adhesive. The gap filler can also be electrically connected to both the electrically conductive glass and the substrate using solder.

Turning now to FIG. 5, a diagrammatic side view of LC cell 102 and substrate 118 is shown prior to the assembly into LCOS panel 100 by die-attaching the silicon backplane die 104 to substrate 118. Gap filler 150 can be electrically and physically attached to electrically conductive glass 108 using electrically conductive bonding material 158 prior to the die-attach. The gap filler can be attached to the electrically conductive glass by applying the bonding material to the gap filler and/or the electrically conductive glass after which the gap filler can be scrubbed into electrically conductive layer 112 by moving the gap filler while the gap filler is in contact with the conductive glass. Scrubbing the gap filler against the electrically conductive glass abrades the polyimide layer of the electrically conductive glass and can result in a low resistance contact between electrical conductor layer 112 and gap filler 158. Electrically conductive bonding material 156 can be applied to bond pad 154 on substrate 118 and the LC cell, with the gap filler electrically connected, can be die-attached to substrate 118 to produce LCOS panel 100. The gap filler can be electrically connected to substrate 118 at substantially the same time that the LC cell is die-attached to the substrate by contacting bonding material 156 on the substrate. Wire bonds 124 (FIG. 2 and FIG. 4) can be connected to bond pads 122 and traces 120 following the die-attach.

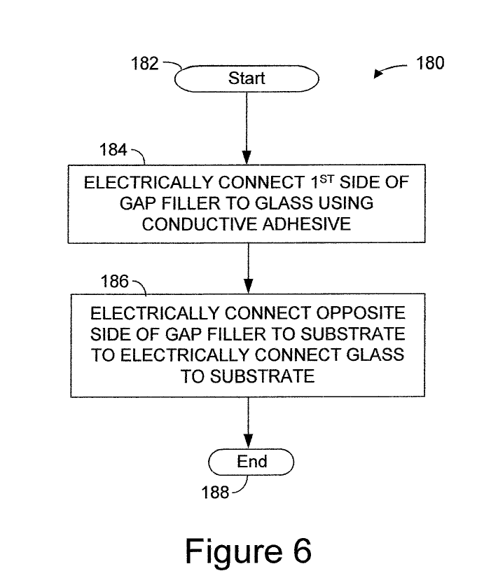

Turning now to FIG. 6, a flow diagram illustrating an embodiment of a method in a liquid crystal display panel is generally indicated by the reference number 180. Method 180 begins at 182 and proceeds to 184 where a first side of the gap filler is electrically connected to the electrically conductive glass using a conductive adhesive. Method 180 then proceeds to 186 where an opposite side of the gap filler is electrically connected to the substrate to electrically connect the electrically conductive glass to the substrate through the gap filler and the conductive adhesive. Method 180 then proceeds to 188 where the method ends.

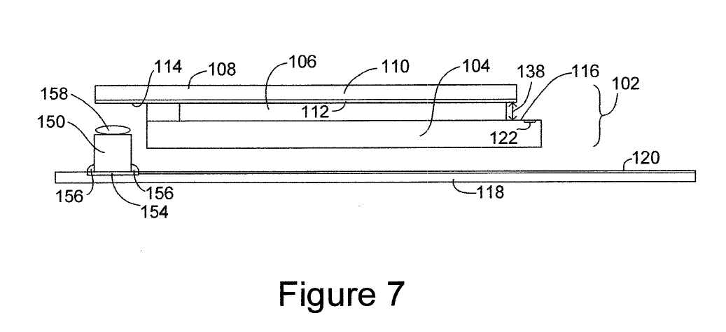

Turning now to FIG. 7, another diagrammatic side view of LC cell 102 and substrate 118 is shown prior to the assembly into LCOS panel 100 by die-attaching silicon backplane die 104 to substrate 118. Gap filler 150 can be electrically connected to substrate 118 prior to die-attaching silicon backplane die 104 to substrate 118 using bonding material 156 such as a conductive adhesive or solder. Once the gap filler is connected to substrate 118, bonding material 158 can be applied to the opposite side of the gap filler from the attachment to substrate 118 and/or to the electrically conductive glass. LC cell 102 can then be die-attached to substrate 118, using conventional die-attach methods, at which time the electrically conductive glass is moved into position to electrically connect the electrically conductive glass to the gap filler through electrically conductive bonding material 158 to complete the LCOS panel. Wire bonds 124 (FIG. 2 and FIG. 4) can be connected to bond pads 122 and traces 120 following the die-attach.

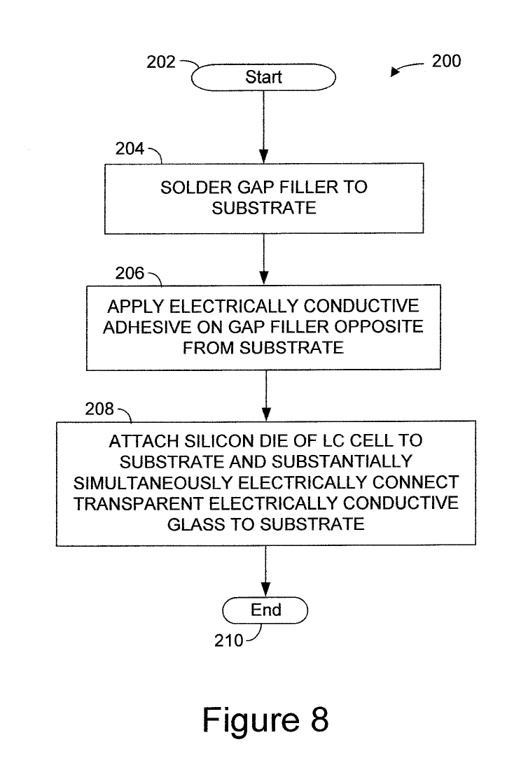

Turning now to FIG. 8, a flow diagram illustrating an embodiment of a method in a liquid crystal display panel is generally indicated by the reference number 200. Method 200 begins at 202 and proceeds to 204 where a first side of the gap filler is electrically connected to the substrate, for example, by soldering. Method 200 then proceeds to 206 where an electrically conductive adhesive is applied to an opposite side of the gap filler from the substrate. Method 200 then proceeds to 208 where silicon backplane die 104 is die-attached to the substrate substantially simultaneously to the electrically conductive glass being electrically connected to the substrate through the gap filler and electrically conductive adhesive. Method 200 then proceeds to 210 where the method ends.

The foregoing descriptions of the invention have been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

What is claimed is:

1. A liquid crystal panel comprising:
a substrate;
a silicon backplane die attached to the substrate;
a transparent electrically conductive glass supported by the silicon backplane die and arranged to overhang the silicon backplane die such that an overhang gap is created between the electrically conductive glass and the substrate;
a liquid crystal material captured between the silicon backplane die and the transparent electrically conductive glass; and
an electrically conductive gap filler positioned in the overhang gap to form at least a portion of an electrical connection between the substrate and the transparent electrically conductive glass.

2. The liquid crystal panel of claim 1 wherein the electrically conductive gap filler is metal.

3. The liquid crystal panel of claim 2 wherein the electrically conductive gap filler is gold plated copper.

4. The liquid crystal panel of claim 2 wherein the electrically conductive gap filler is gold plated bronze.

5. The liquid crystal panel of claim 1 wherein the electrically conductive gap filler is metal plated ceramic.

6. The liquid crystal panel of claim 1 wherein the electrically conductive gap filler is cylindrical having a diameter and which is positioned to conduct electricity substantially across the diameter across the overhang gap.

7. The liquid crystal panel of claim 6 wherein the diameter of the electrically conductive gap filler is approximately 0.6 mm across the overhang gap.

8. The liquid crystal panel of claim 1 wherein the electrically conductive gap filler is soldered to the substrate and is electrically connected to the transparent electrically conductive glass using an electrically conductive adhesive.

9. The liquid crystal panel of claim 1 wherein the electrically conductive gap filler is electrically connected to the substrate and to the transparent electrically conductive glass by a conductive adhesive.

10. The liquid crystal panel of claim 1 wherein the electrically conductive gap filler is electrically connected to the transparent electrically conductive glass using a conductive adhesive.

11. The liquid crystal panel of claim 10 wherein the conductive adhesive is less than approximately 0.1 mm thick across the overhang gap.

12. The liquid crystal panel of claim 1 wherein the electrically conductive gap filler has a coefficient of thermal expansion (CTE) that is closer to a CTE of the silicon die than to a CTE of the conductive adhesive.

13. The liquid crystal panel of claim 1 wherein the transparent electrically conductive glass includes a polyimide layer with an abraded area electrically connected to the electrically conductive gap filler by a conductive adhesive.

14. The liquid crystal panel of claim 1 wherein the gap filler is non-adhesive.

15. A method comprising:
powering a transparent electrically conductive glass of a liquid crystal cell directly from a trace conductor on a substrate at least in part through an electrically conductive gap filler that is arranged in a gap formed between the electrically conductive glass and the substrate.
